(19) United States
(12) Patent Application Publication
(10) Pub. No.: US 2023/0023411 A1
(43) Pub. Date: Jan. 26, 2023

(54) CONTROL OF A REDUNDANT BRAKE DEVICE SYSTEM

(71) Applicant: VOLVO TRUCK CORPORATION, Göteborg (SE)

(72) Inventors: Leo LAINE, Härryda (SE); Leon HENDERSON, Härryda (SE); Christian OSCARSSON, Stenungsund (SE)

(73) Assignee: VOLVO TRUCK CORPORATION, Göteborg (SE)

(21) Appl. No.: 17/756,850

(22) PCT Filed: Dec. 10, 2019
(86) PCT No.: PCT/EP2019/084369

§ 371 Date: Jun. 3, 2022

(51) Int. Cl. B60T 8/17; B60T 8/1755; B60T 8/18; B60T 8/32

(52) U.S. Cl. CPC B60T 8/1708; B60T 8/323; B60T 8/329; B60T 8/1881; B60T 8/17551; B60T 2210/12; B60Y 2306/13; B60Y 2400/81

(57) ABSTRACT

A braking system for a heavy duty vehicle includes a first brake controller arranged to control braking on a first wheel and a second brake controller arranged to control braking on a second wheel, based on a respective configured wheel slip limit and on a respective brake torque request, wherein the first and the second brake controllers are interconnected via a back-up connection arranged to allow one of the first and the second brake controller to assume braking control of the wheel of the other of the first and the second brake controller in case of brake controller failure, the braking system comprising a control unit arranged to, in response to brake controller failure, reduce the configured wheel slip limit associated with the failed brake controller to a reduced wheel slip limit.

### TECHNICAL FIELD

The present disclosure relates to redundancy in braking systems for heavy duty vehicles. The disclosure is particularly relevant to vehicles configured for autonomous drive. The invention can be applied in heavy-duty vehicles, such as trucks and construction equipment. Although the invention will be described mainly with respect to cargo transport vehicles such as semi-trailer vehicles and trucks, the invention is not restricted to this particular type of vehicle but may also be used in other types of vehicles such as cars.

### BACKGROUND

The braking system of a heavy duty vehicle is key to safe vehicle operation. The braking system not only limits vehicle velocity when needed, but also plays an important role in maintaining vehicle stability. A heavy duty vehicle with a malfunctioning brake system therefore represents a significant risk. It is desired to minimize this risk.

To ensure that the vehicle does not lose braking capability, or becomes unstable due to a malfunctioning braking system, redundancy may be added to the braking system. Redundancy may be added both the control system as well as to the actuators, e.g., the disc or drum brakes.

In order to achieve redundancy in the vehicle braking system, a brake system layout that includes two or more independently controlled complete brake systems that are either arranged in parallel or in series is commonly used. Thus, if one system fails, a back-up system is available to assume control and operate the vehicle brakes. However, this type of redundancy drives overall vehicle cost and also complicates brake system servicing.

US 2017/0210361 A1 discloses a brake controller layout for a heavy-duty vehicle comprising redundancy.

It is important that vehicle stability and overall control is not negatively affected when switching to the redundant brake system.

### SUMMARY

It is an object of the present disclosure to provide redundant brake systems which are robust in the sense that safe vehicle operation and controllability is maintained during and after a brake device failure. This object is at least in part obtained by a braking system for a heavy duty vehicle. The braking system comprises a first brake controller arranged to control braking on a first wheel, and a second brake controller arranged to control braking on a second wheel, based on a respective wheel slip limit and on a respective brake torque request, wherein the first and the second brake controllers are interconnected via a back-up connection arranged to allow one of the first and the second brake controller to assume braking control of the wheel of the other of the first and the second brake controller in case of brake controller failure. The braking system also comprises a control unit arranged to, in response to brake controller failure, reduce the wheel slip limit associated with the failed brake controller to a reduced wheel slip limit.

By adding an extra safety margin to the set wheel slip limit, i.e., by configuring the reduced wheel slip limit, wheel slip becomes unlikely despite operating with a failed brake controller. This way it becomes easier to predict vehicle response to control inputs, which is an advantage.

According to aspects, the first brake controller is arranged to control braking on a front axle left wheel, and the second brake controller is arranged to control braking on a front axle right wheel, whereby the first and second brake controllers are arranged as fail-operational brake controllers. The herein disclosed techniques are particularly suitable for controlling slip limits imposed on front axle brake controllers, since they play an important role in vehicle control, especially during hard braking maneuvers. By the disclosed techniques, safe vehicle operation and ability to generate lateral tyre forces can be maintained despite brake controller failure on a front axle brake device.

According to aspects, the control unit is arranged to obtain data related to road friction from a functional brake controller, and to configure the wheel slip limit associated with the failed brake controller in dependence of the data related to road friction. This way the safety margin can be adjusted depending on driving scenario, which leads to increased overall control efficiency. In case road friction conditions are favorable, i.e., when road traction is good, a smaller safety margin may be added to the imposed wheel slip limit, while less favorable driving conditions may imply a larger safety margin added to the wheel slip limit imposed on the failed brake controller operating via the back-up connection.

According to aspects, the data related to road friction comprises a peak wheel slip value detected by the functional brake controller and/or road friction coefficient estimated by the functional brake controller. Knowing peak wheel slip value and/or estimated road friction allows for setting the wheel slip limit of the failed brake controller in a reliable and efficient manner.

According to aspects, the reduced wheel slip limit is determined based on a table of reduced slip limits, wherein the table of reduced slip limits is configured to be indexed by a wheel slip value determined for a wheel on the same side of the vehicle as the failed brake controller. Thus, from previous experimentation and/or analysis, a set of wheel slip limits for different driving conditions is stored in the table. A suitable wheel slip limit can then be selected based on the current driving scenario. For instance, suppose a front left brake controller fails, while favorable traction conditions are seen by the same side rear axle brake controllers, then a smaller reduction in posed wheel slip limit on the failed brake controller may be tabulated compared to the case when the same side rear axle brake controllers detect low friction conditions.

According to aspects, the reduced wheel slip limit is determined as the smallest peak wheel slip detected by a functional brake controller of a wheel on the same side of the vehicle as the failed brake controller, and reduced by a pre-determined safety factor.

This is a robust straight forward way to set the reduced wheel slip limit. The reduced wheel slip limit will vary depending on driving conditions in a local road area, while being robust due to the addition of the safety margin. The safety margin may, e.g., be on the order of 20% of the initially imposed wheel slip limit.

According to aspects, the control unit is arranged to increase brake torque and/or wheel slip limit on one or more trailer wheels in response to front axle brake controller failure. This effectively means that the trailer is used as anchor in order to slow down a vehicle combination suffering failure on a front axle brake controller. The tractor may, e.g., have entered some distance into a turn, where significant lateral forces are needed in order to successfully negotiate the turn, while the trailer is still not subject to large lateral forces since it has not entered as far into the turn. In case of wheel slip on the front axle wheels, the tractor may not be able to generate the required lateral forces. Slowing down the vehicle combination using the trailer may allow the tractor unit to regain road purchase and thus generate the required lateral forces.

According to aspects, the control unit is arranged to increase the configured wheel slip limit associated with the failed brake controller from the reduced wheel slip limit up to a back-up mode wheel slip limit. After the failure has taken place, and control algorithms and operations have stabilized, the slip situation can be evaluated. The effects of the brake controller failure on vehicle controllability can be reduced by increasing wheel slip level up towards the initially configured wheel slip limit that was in place prior to the brake controller failure, but only if driving conditions are such as to warrant an increase in imposed wheel slip limit of the failed brake controller.

According to aspects, a wheel speed sensor associated with a wheel on the front axle is arranged cross-wise connected to a brake controller associated with a wheel on the other side of the front axle. This cross-wise connection allows a WEM to monitor wheel speed on a wheel that it is controlled via the back-up connection. This increases the controllability and observability of the wheel associated with the failed brake controller, which is an advantage.

According to aspects, the vehicle comprises first and second rear wheel axles, wherein a wheel speed sensor associated with a wheel on the first rear axle is arranged connected to a brake controller associated with a wheel on the second rear wheel axle and on the same side as the wheel on the first rear axle. Thus way a brake controller on the rear axle is able to obtain wheel speed data from a wheel on the same side of the vehicle as its own wheel, which is an advantage. For instance, wheel lift-off may be detected by comparing the two or more different wheel speed measurements. Imposed wheel slip limit can be reduced in response to detecting wheel lift-off.

There is also disclosed herein methods, control units, computer programs, computer readable media, computer program products, and vehicles associated with the above discussed advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of embodiments of the invention cited as examples. In the drawings:

FIGS. 1A-C schematically illustrate example vehicles;

FIGS. 2A-B show example interconnected brake controllers;

FIGS. 3A-B show example driving scenarios;

FIG. 4 illustrates an example brake device layout;

FIG. 5 schematically illustrates a control unit and wheel end module assembly;

FIG. 6 is a graph showing relationships between tyre forces and wheel slip;

FIG. 7 is a graph showing an example of configured slip limits over time;

FIG. 8 is a flow chart illustrating methods;

FIG. 9 schematically illustrates a control unit; and

FIG. 10 shows an example computer program product.

### DETAILED DESCRIPTION OF EXAMPLE EMBODIMENTS OF THE INVENTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

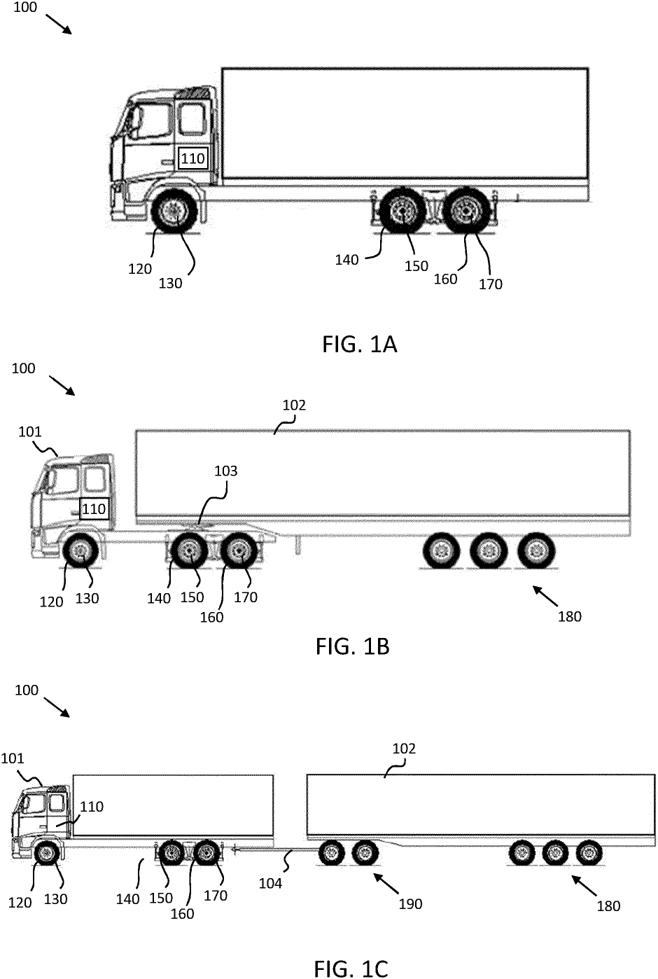

FIGS. 1A-C illustrate a number of example vehicles 100 for cargo transport. FIG. 1A shows a truck supported on wheels 120, 140, and 160, some of which are driven wheels.

FIG. 1B shows a semitrailer vehicle combination where a tractor unit 101 tows a trailer unit 102. The front part of the trailer unit 102 is supported by a fifth wheel connection 103, while the rear part of the trailer unit 102 is supported on a set of trailer wheels 180.

FIG. 1C shows a truck with a dolly unit 104 arranged to tow a trailer unit 102. The front part of the trailer unit is then supported on a set of dolly wheels 190, while the rear part of the trailer is supported on a set of trailer wheels 180.

Each vehicle 100 comprises a control unit 110, such as a vehicle motion management (VMM) control module. This control unit may potentially comprise a number of sub-units distributed across the vehicle 100, or it can be a single physical unit. The control unit controls vehicle operation. The control unit 110 may, e.g. allocate brake force between wheels to maintain vehicle stability. Each of the wheel brake controllers is communicatively coupled to the control unit 110, allowing the control unit to communicate with the brake controllers, and thereby control vehicle braking.

Vehicle combinations such as those discussed above are known in general and will not be discussed in more detail herein. The techniques disclosed herein are applicable to a wide range of different vehicle combinations and vehicle types, not just to the combinations shown in FIGS. 1A-1C. It is furthermore appreciated that the techniques disclosed herein are also applicable to, e.g., an electrically powered vehicles or a hybrid electric vehicles.

Each wheel is associated with a wheel brake 130, 150, 160 (trailer unit wheel brakes are not indicated in FIGS. 1A-1C). This wheel brake may, e.g., be a pneumatically actuated disc brake or drum brake, but some aspects of the disclosure are also applicable for regenerative brakes which produce electrical power during vehicle retardation.

The wheel brakes are controlled by brake controllers. Herein, the terms brake controller, brake modulator, and wheel end module will be used interchangeably. They are all to be interpreted as a device which controls applied braking force on at least one wheel of a vehicle, such as the vehicle 100. A service brake system is a system which brakes the vehicle during drive operation, as opposed to a parking brake system which is configured to keep the vehicle in a fixed position when parked.

Brake force will herein be quantified as brake torque. It is straightforward to translate between brake torque and brake force.

For the brake system it is desirable that, in the event of a single electrical failure, no or limited loss of braking performance (maximum deceleration capability) and no or limited loss of vehicle stability occurs. Most known service brake systems can only fulfil this requirement if two service brake systems are installed in parallel, resulting in a doubling of parts, piping and air fittings.

Recent development in service brake systems, however, comprises an arrangement that instead includes individual brake controllers at each wheel of the vehicle. In normal operation each brake controller is responsible for controlling the brake force, preventing wheel locking and carrying out diagnostics on a respective wheel of the controller. However, in addition to this, a control output of each controller can also be connected to a ‘back-up’ port on one of the other brake controllers. This way a controller can assume the function of a faulty controller by operating its connection to the back-up port of the faulty controller. The connection to the back-up port may be a pneumatic connection. The faulty controller then only needs to open up access between the back-up port and the brake actuator in order to allow an external controller to control wheel braking by the actuator of the failed controller.

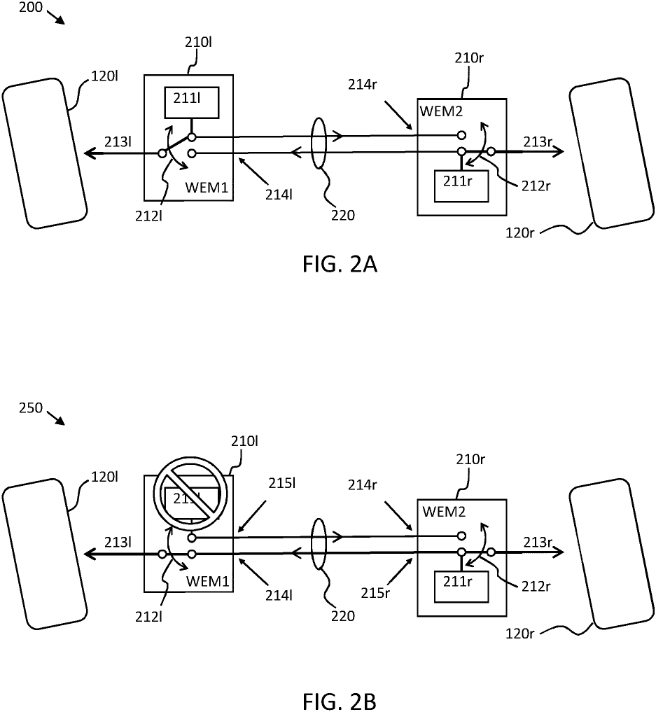

FIGS. 2A-B schematically illustrate a set-up 200, 250 like this; a left wheel end module (WEM) 2101 is arranged to control braking of a left front axle wheel 1201 via a control connection 2131. The control connection may, e.g., be a pneumatic connection for actuating a disc brake or the like. A right WEM 210r is arranged to control braking of a right front axle wheel 120r via a similar control connection 213r.

The two WEMs are linked by a back-up connection 220, allowing each WEM to assume control of the braking of the other wheel. Thus, if one of the WEMs fail the other can take over in order to maintain vehicle braking capacity, effectively providing brake control redundancy.

Each WEM 2101, 210r comprises means 2111, 211r for generating braking force on its respective wheel. In a default mode (shown in FIG. 2A), where both WEMs 2101, 210r are fully functional and operation as intended, the back-up ports 2141, 214r are disconnected from the respective wheel brake by switches 2121, 212r. These ‘switches’ may, e.g., be pneumatic valves in case the back-up connection 220 is a pneumatic connection. If a WEM 2101, 210r fails, it flips its respective switch 212l, 212r such that the other WEM can assume control via the control connection 220. The change in mode from an active mode where the controller is in control of the brake to a slave mode where the controller passes control to the other controller may be automatically triggered by, e.g., loss of electrical power or the like.

When one front axle WMM 2101, 210r fails, it may therefore use the other (still functional) WEM for brake control. The switch 2121, 212r may be operated automatically upon WEM failure, or it may be operated remotely from the control unit 110. In case the switch is a pneumatic valve, the valve may, e.g., be default open and/or remotely controllable from the control unit 110, i.e., if the brake controller dies, the valve automatically opens (either on its own or by external control signal) to allow control by the other brake controller.

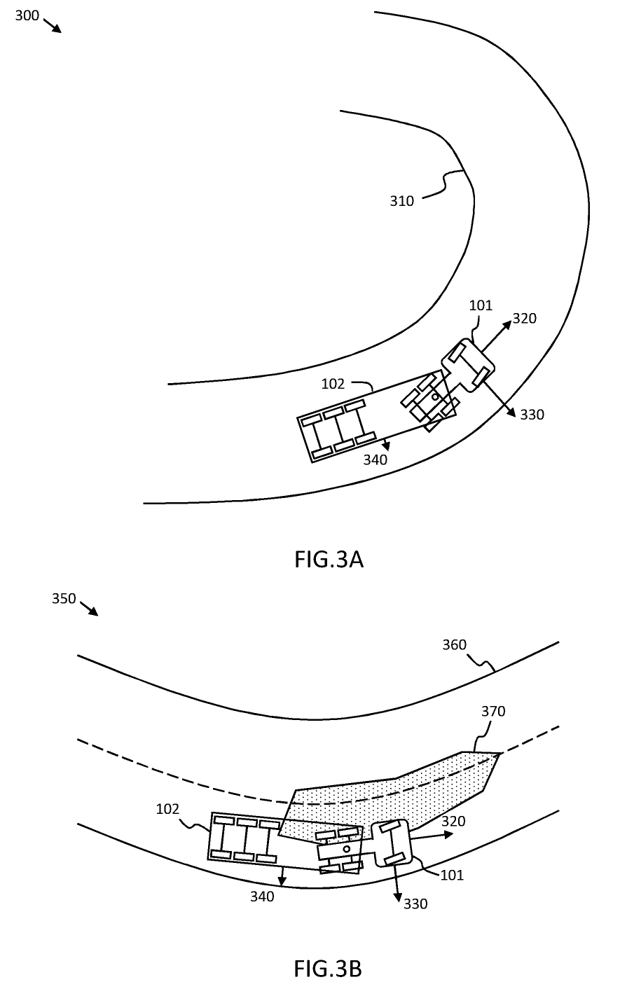

FIG. 2B schematically illustrates a scenario 250 where the left front axle controller 2101 has failed. If, for instance, the left wheel 1201 brake controller 2101 suffers an electrical fault it will automatically fail to a state that passes the pneumatic pressure applied to its back-up port 2141, such that the back-up connection 220 becomes connected to the control connection 2131. Both wheels 1201, 120r will therefore now be controlled by the right hand brake controller 210r as shown in FIG. 3, with the failed controller 2101 acting as a slave, making the overall system 200 fail-operational.

However, a vehicle operating according to the scenario 250, where a brake controller has failed and a functional controller controls both its own brake and that of the failed controller, may face challenges when negotiating difficult driving scenarios. This is at least in part because of the longer control connection between controller and actuator via the back-up connection, which may limit control loop bandwidth.

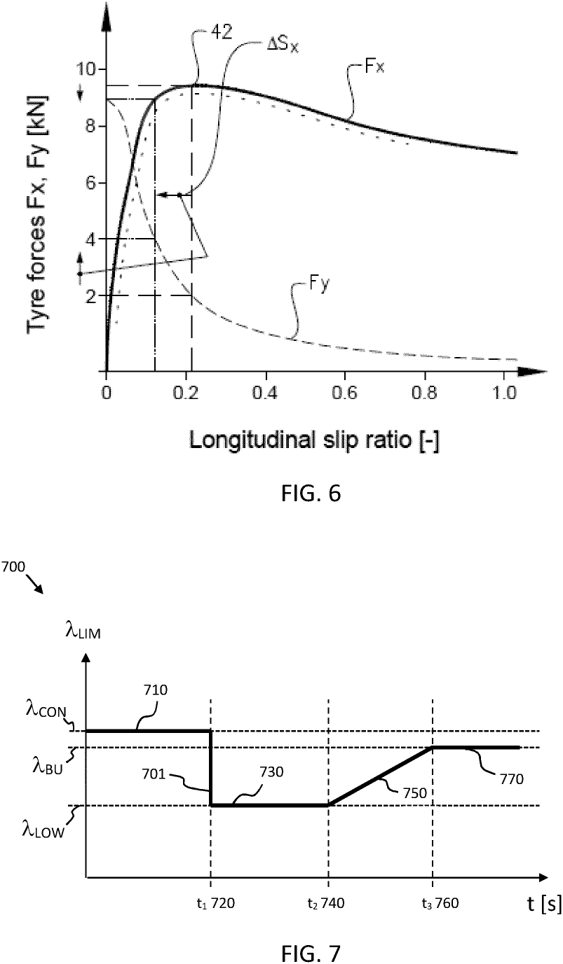

FIG. 3A shows a scenario 300 where the tractor unit 101 enters a road stretch 310 with a closing curve characteristic. To negotiate the curve, the vehicle combination 101, 102 needs to be able to generate significant lateral forces 330, 340 in addition to the longitudinal force 320. This is only possible if wheel slip is kept below a limit, as shown in FIG. 6, where Fₓ is tyre (or wheel) longitudinal force, F_{y} is tyre (or wheel) lateral force. It is seen in

FIG. 6 that, as longitudinal wheel slip increases, the ability to generate lateral forces F_{y} decrease significantly. Wheel slip control ability may be limited when operation is based on the back-up connection 220, since control loop time constants and the like may be prolonged compared to normal operation. It is important that the vehicle combination is able to maintain operation where wheel slip is controlled, even when confronted with WEM failure.

FIG. 3B shows another scenario 350 where the vehicle combination 101, 102 enters a road stretch 360 with a patch 370 having low friction, such as a locally icy area. This low friction area 370 may cause significant wheel slip on one side of the vehicle combination 101, 102, which in turn will limit the ability of the vehicle to generate sufficient lateral forces to negotiate the curve. Again, it is important that the vehicle combination is able to maintain operation where wheel slip is controlled, even when confronted with WEM failure.

Some of the techniques disclosed herein takes advantage of the interface used between a VMM and the brakes. As described in PCT/EP2016/063782 the VMM domain may send wheel torque request and wheel slip limit to each local brake controller. This limit is usually selected to give maximum braking performance. However, when one wheel unit has failed, this slip limit is herein manipulated to a lower value than normal. This value can correspond to a value that is still within the linear region of the tyres force vs slip curve for all foreseeable road conditions (see FIG. 6). This will prevent wheel lock on both wheel, therefore preventing undesired loss of lateral tyre force.

Note that, in both scenarios 300, 350, the VMM or vehicle control unit 110 may use the trailer 102 as an ‘anchor’ in order to slow down the vehicle and avoid significant wheel slip. In other words, according to aspects, the vehicle control unit 110 is arranged to increase brake torque and/or wheel slip limit on one or more trailer wheels in response to front axle brake controller failure. This effectively means that the trailer is used as anchor in order to slow down a vehicle combination suffering failure on a front axle brake controller. The tractor may, e.g., have entered some distance into a turn, where significant lateral forces are needed in order to successfully negotiate the turn, while the trailer is still not subject to large lateral forces since it has not entered as far into the turn. In case of wheel slip on the front axle wheels, the tractor may not be able to generate the required lateral forces. Slowing down the vehicle combination using the trailer may allow the tractor unit to regain road purchase and thus generate the required lateral forces.

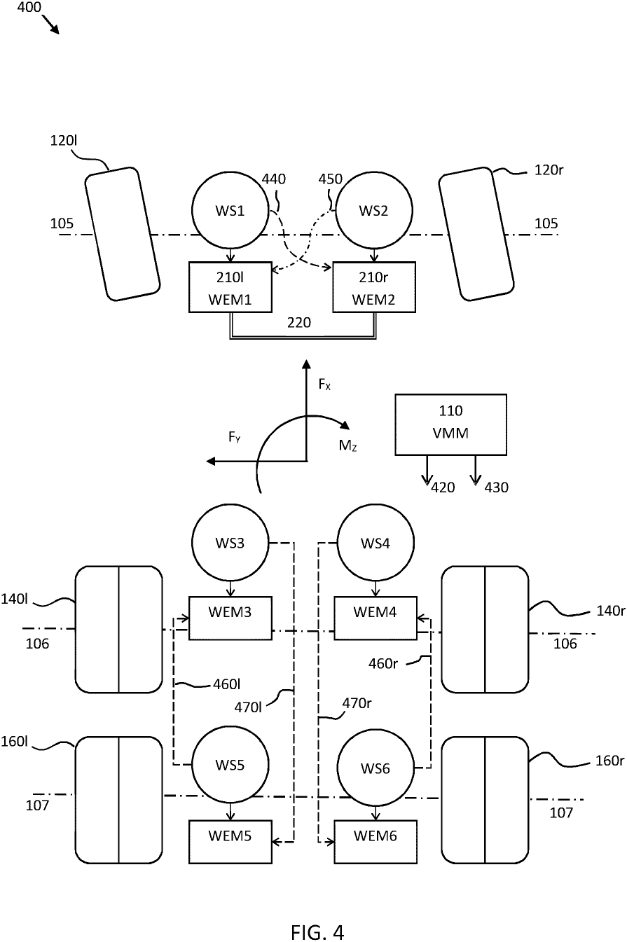

FIG. 4 shows an example brake device system 400 layout according to the present teaching. There are two front axle wheels 120l, 120r, and four rear axle wheels 140l, 160l, 140r, 160r. Each wheel has a corresponding WEM, numbered from 1 to 6 in FIG. 4. Each wheel also has at least one associated wheel speed sensor (WS), numbered from 1 to 6 in FIG. 4. Wheel speed sensors and their use for vehicle control is known and will not be discussed in more detail herein.

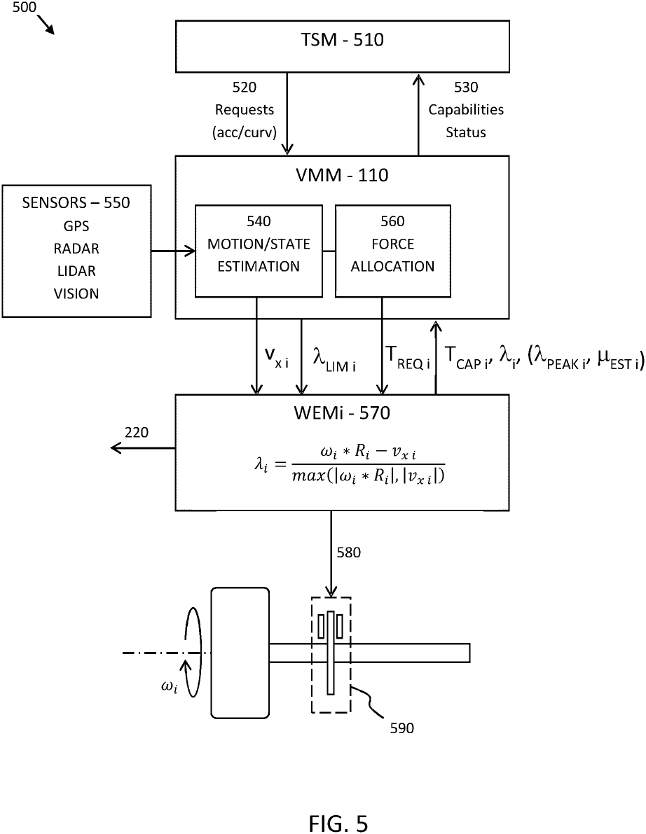

A vehicle motion management module (VMM) is a control unit 110 arranged to control at least part of the vehicle braking functionality. This unit will be discussed in more detail below in connection to FIG. 5. As noted above, the VMM may not only use the braking system for deceleration of the vehicle 100, but also for controlling vehicle stability as it maneuvers, e.g., using the trailer 102 as an anchor as discussed above in connection to FIGS. 3A and 3B.

Front axle WEMs 210l, 210r are arranged to be fail operational. Herein, ‘fail operational’ means that one controller may fail without the vehicle loosing significant braking capability, since the other controller will take over via the back-up connection 220. Also, vehicle stability will likely not be critically affected since braking capability on the front axle wheels is substantially maintained. A failed WEM on the front axle will set the switch 212l, 212r (not shown in FIG. 4) to open stage and the still functioning WEM on the front axle takes control of the other wheel also.

Each wheel 120l, 120r on the front axle 105 has an associated wheel speed sensor WS1, WS2. The data from the wheel speed sensor may be used to control braking in a known manner. Cross-connections 440, 450 between one or more wheel speed sensors on one side of the vehicle may be connected to the brake controller on the other side of the vehicle. Rear axle WEMs, i.e., WEM 3, WEM 4, WEM 5, WEM 6 in FIG. 4, are, according to some aspects, arranged to be fail silent. Herein, ‘fail silent’ means that one controller may fail without any back-up controller stepping in to maintain braking capability on the corresponding wheel. The wheel of the failed controller then effectively becomes an unbraked free-running wheel. For the rear axles, the WEMs on one side share the wheel speeds sensors for redundancy, as shown in FIG. 4 by connections 460l, 460r, 470l, 470r. This way at least hard braking can be made even with a failed wheel speed sensor on a rear axle wheel.

It is appreciated that first rear axle 106 brake controllers WEM3, WEM4 may, according to some aspects, be arranged in fail-operational mode as shown in FIGS. 2A and 2B instead of in fail-silent mode as shown in FIG. 4.

It is furthermore appreciated that second rear axle 107 brake controllers WEM5, WEM6 may, according to some aspects, be arranged in fail-operational mode as shown in FIGS. 2A and 2B instead of in fail-silent mode as shown in FIG. 4.

An advantage with connecting wheel speed sensors on different rear axles to a brake controller is that the brake controller can compare the different wheel speeds and thereby detect, e.g., wheel lift-off conditions and the like. This detection may be communicated to the control unit 110.

FIG. 5 schematically shows a system for vehicle control. A traffic situation management (TSM) module 510 plans a vehicle trajectory and, based on the planned trajectory, requests acceleration and curvature profiles 520 from the VMM 110. The VMM 110 responds back with current vehicle capabilities and status 530, whereby the TSM module can update and maintain the planned trajectory to, e.g., ensure vehicle safety while optimizing vehicle operation.

The VMM module 110 has access to various forms of sensor data 550 from which a vehicle state can be inferred. The sensor data may, e.g., comprise external data from any combination of: one or more global positioning system (GPS) receivers, one or more radio detection and ranging (radar) transceivers, one or more light detection and ranging (lidar) transceivers, and one or more vision based sensors, such as cameras and the like. Sensor data may also comprise internal sensor data from, e.g., wheel speed sensors, steering angle sensors, brake and drive torque estimators, inertial measurement unit (IMU) sensors, and the like.

The external and the internal sensor data is input to a motion and state estimation module 540 which filters the data and estimates vehicle state. Such motion and state estimation modules are known and will not be discussed in more detail herein. The vehicle state may comprise variables related to, e.g., position of the chassis in a global reference system, roll, pitch and yaw in the global reference system, as well as longitudinal velocities νₓᵢ for each wheel in a local wheel reference frame. Knowing as longitudinal velocities νₓᵢ for each wheel, in the coordinate system of the wheel, is important, as it allows the system to accurately determine wheel slip λ.

The VMM or control unit 110 determines a force allocation 560 to meet the requests from the TSM module 510. This force allocation may comprise setting torque requests T_{REQ} ᵢ on specific wheel brakes as well as controlling propulsion sources and steering angles.

The VMM module also specifies a wheel slip limit for each WEM, λ_{LIM} ᵢ, to be adhered to by the given WEM. Thus, with reference to FIG. 5, a WEM, say the i-th WEM 570, receives wheel speed νₓᵢ, wheel slip limit λ_{LIM} ᵢ, and torque request T_{REO} ᵢ. Based on the received parameters, the WEM controls 580 its respective brake device 590 and potentially also a failed WEM via the back-up connection 220.

The WEM may determine (and report back) a current wheel slip

$${λ}_{i} = \frac{{ω}_{i} ∗ {R}_{i} - {v}_{x i}}{m a x \left(\left|{ω}_{i} ∗ \left.{R}_{i}\right| , \left|{v}_{x} \left.{}_{i}\right|\right.\right.\right)}$$

where ωᵢ is wheel rotational velocity and Rᵢ is wheel radius. According to this definition, slip is positive for propulsion slip and negative for braking slip. However, in the following, when limits on wheel slip are discussed, the limit refers to the absolute value of wheel slip. Thus, an increased wheel slip limit refers to either a larger allowed positive wheel slip limit or a smaller allowed negative wheel slip limit according to the definition above.

The largest wheel slip λ_{PEAK} ᵢ detected over a time window may be reported back to the VMM, and also an estimated road friction coefficient µ_{EST} ᵢ. The estimated road friction coefficient may correspond to a value µ such that achievable lateral tyre force F_{y} is limited by

$${F}_{y} \leq μ \text{} {F}_{z}$$

where F_{z} is the normal force acting on a tyre. The WEM may also determine and report back a current torque capability T_{CAP} ᵢ.

If a WEM fails and enters slave mode, where the back-up connection 220 is used to control wheel braking on the wheel associated with the failed controller, the wheel slip limit λ_{LIM} ᵢ is adjusted as discussed above. An example wheel slip limit for a failing WEM is shown vs time in FIG. 7. The slip limit λ_{LIM} shown in FIG. 7 is the slip limit effectively applied to both wheels on the axle where one brake controller configured in fail-operational mode has failed.

The WEM is initially configured with some wheel slip limit λ_{CON} 710. The WEM then, at time t₁ 720, fails for some reasons, and enters slave mode where wheel brake control is via the back-up connection 220. When this happens, the wheel slip limit is automatically reduced 601 down to a reduced wheel slip limit λ_{LOW} 730. This reduced wheel slip limit implies that the vehicle control is executed with larger safety margins where wheel slip is unlikely. The reduced wheel slip limit may, e.g., correspond to a region of linear obtainable tyre lateral force.

The reduced wheel slip limit λ_{LOW} 730 is then maintained for a period of time up to time t₂. At time t₂ is has been determined that vehicle control safety margins can be reduced, e.g., due to other WEMs reporting low peak wheel slip values λ_{PEAK} and/or high estimated road friction conditions µ_{EST}.

The wheel slip limit associated with the failed WEM is then, at time t₂ 740, gradually increased 750 up to a back-up wheel slip limit value λ_{BU} 770 which is reached at time t₃ 760. This back-up wheel slip limit value λ_{BU} 770 may equal the originally configured wheel slip limit λ_{CON} 710, or it can be some other value. The back-up wheel slip limit value is, however, often below the wheel slip limit value used when the brake controller is fully functional.

It is appreciated that there may be some difference in desired control strategy if the system includes the cross connections 440, 450 of wheel speed sensors or not. For the case where no cross connection of wheel speed sensors exit the functioning WEM will control the applied brake pressure (sent to both wheels) according to the wheel speed measured on just one wheel. It is in that case important to select a slip limit with sufficient safety margin so that it is unlikely that wheel lock will occur on the wheel with a faulty controller where no feedback exists. For the case where cross connections 440, 450 of wheel speed sensor output exists, the functioning brake controller can follow the slip limit with a ‘select low’ approach - i.e. the brake pressure will be controlled at a level such that neither wheel is allowed to exceed the configured slip limit. To summarize, FIG. 7 shows an example of operations in a braking system for a heavy duty vehicle 100. The braking system comprises a first brake controller WEMi, 570, arranged to control braking on a first wheel 120, 150, 170, and a second brake controller WEMi, 570, arranged to control braking on a second wheel 120, 150, 170, based on a respective wheel slip limit λ_{LIM i}, and on a respective brake torque request T_{REO} ᵢ. The first and the second brake controllers are interconnected via a back-up connection 220 arranged to allow one of the first and the second brake controller to assume braking control of the wheel of the other of the first and the second brake controller in case of brake controller failure. The braking system comprises a control unit 110 arranged to, in response to brake controller failure, reduce 701 the configured wheel slip limit λ_{CON}, 710, associated with the failed brake controller to a reduced wheel slip limit λ_{LOW}, 730.

This means that vehicle control margins are increased in response to brake controller failure. The increased margins may, e.g., be warranted since there will be some additional delay in the braking system due to the added length of control connections between the master brake controller operating the back-up connection 220 and the failed brake controller operating in slave mode.

Normally, although not necessarily, the first brake controller 570, WEM1, is arranged to control braking on a front axle 101 left wheel 120l, and the second brake controller 570, WEM2 is arranged to control braking on a front axle 101 right wheel 120r, whereby the first and second brake controllers are arranged as fail-operational brake controllers. This set-up was exemplified and discussed above in connection to FIGS. 2A and 2B.

According to some aspects, the control unit 110 is arranged to obtained data related to road friction from a functional brake controller, and to configure the wheel slip limit λ_{LIM} ᵢ associated with the failed brake controller in dependence of the data related to road friction. Thus, in case road friction conditions are favorable, the wheel slip limit λ_{LIM} ᵢ associated with the failed brake controller may be increased by an amount, since no significant safety margins may be needed. On the other hand, if road friction conditions reported by functional brake controllers are not favorable, e.g., due to wet or icy road conditions, the safety margin may even need to be increased beyond that originally configured.

According to some such aspects, the data related to road friction comprises a peak wheel slip value λ_{PEAK} detected by the functional brake controller. The peak wheel slip value is an indication of the road friction conditions. For instance, in case some controller has detected high wheel slip values, then a significant safety margin may be warranted, and vice versa. The functional brake controller used to determine road friction conditions is preferably a brake controller associated with a wheel on the same side of the vehicle 100 as the failed brake controller. This is because the road friction conditions detected by a brake controller associated with a wheel on the same side of the vehicle 100 as the failed brake controller is likely to exhibit a larger degree of correlation with the failed brake controller compared to a brake controller on the other side of the vehicle 100.

According to some aspects, the reduced wheel slip limit 730 is determined based on a table of reduced slip limits. This table of reduced slip limits may be configured to be indexed by a wheel slip value determined for a wheel on the same side of the vehicle as the failed brake controller. The table may be pre-determined and stored in the control unit 110.

According to some other aspects, the reduced wheel slip limit is determined as the smallest peak wheel slip detected by a functional brake controller of a wheel on the same side of the vehicle as the failed brake controller, and reduced by a pre-determined safety factor.

With reference to FIG. 7, the control unit 110 may also be arranged to increase the configured wheel slip limit λ_{LIM} ᵢ associated with the failed brake controller from the reduced wheel slip limit λ_{LOW} ᵢ, 730 up to a back-up mode wheel slip limit λ_{BU}, 770. This can, for instance, be done if overall road conditions are found to be favorable. For instance, the road surface may be dry and even with no ice formation, therefore providing favorable braking conditions. The increase is preferably gradual and smooth. For instance, the increase from the reduced wheel slip limit λ_{LOW i}, 730 up to the back-up mode wheel slip limit λ_{BU}, 770 may be a linear function 750 or at least a pricewise linear function such as an increase over a series of consecutive smaller steps. The difference between the back-up mode wheel slip limit λ_{BU}, 770 and the initially configured wheel slip limit may be set according to driving scenario, however, the back-up mode wheel slip limit 770 is preferably below the initially configured wheel slip limit 710.

The control unit 110 shown in FIGS. 4 and 5 may furthermore be arranged to control the braking system 400 via at least a first data bus 420 and a second data bus 430 separate from the first data bus. The first data bus 420 is then arranged to control at least the first brake controller WEM1 and a fourth brake controller WEM4, and the second data bus 430 is arranged to control at least the second brake controller WEM2 and a third brake controller WEM3. This way one of the data busses may fail without the vehicle suffering total loss of braking capability.

FIG. 4 also shows a number of wheel speed sensors arranged in connection to respective wheels. The wheel speed sensors may be cross-wise connected, i.e., optionally, a wheel speed sensor WS1, WS2 associated with a wheel 120l, 120r on the front axle 101 is arranged connected to 440, 450 a brake controller WEM1, WEM2 associated with a wheel 120l, 120r on the other side of the front axle.

According to some aspects, the rear axle WEMs on one side share wheel speeds sensors for redundancy, as shown in FIG. 4 by connections 460l, 460r, 470l, 470r. This way at least hard braking can be made even with a failed wheel speed sensor on a rear axle wheel. Thus, optionally, the vehicle comprises first 106 and second 107 rear wheel axles, wherein a wheel speed sensor WS3, WS4 associated with a wheel 140l, 140r on the first rear axle 102 is arranged connected to 460l, 470r, 460l, 470r a brake controller WEM5, WEM6 associated with a wheel 160l, 160r on the second rear wheel axle 107 and on the same side as the wheel on the first rear axle 102.

An advantage with connecting wheel speed sensors on different rear axles to a brake controller is that the brake controller can compare the different wheel speeds and thereby detect, e.g., wheel lift-off conditions and the like. This detection may be communicated to the control unit 110. When this happens, the control unit 110 may reduce the configured wheel slip limit λ_{LIM} ᵢ associated with the brake controller that detects wheel lift-off.

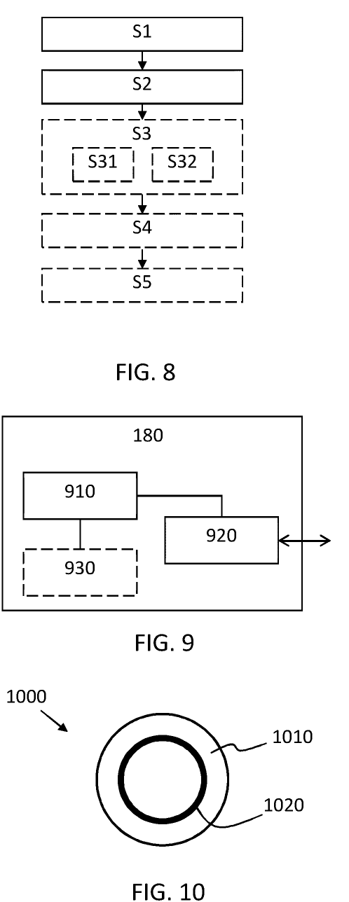

FIG. 8 is a flow chart illustrating a method for braking a heavy duty vehicle 100. Aspects of the method were discussed above in connection to FIG. 6. The method comprises; configuring S1 a braking system comprising a first brake controller 570, WEMi, arranged to control braking on a first wheel 120, 150, 170, and a second brake controller 570, WEMi, arranged to control braking on a second wheel 120, 150, 170, based on a respective configured wheel slip limit λ_{LIM} ᵢ, 570, 600, and on a respective brake torque request T_{REO} ᵢ, 570. The first and the second brake controllers are interconnected via a back-up connection 220 arranged to allow one of the first and the second brake controller to assume braking control of the wheel of the other of the first and the second brake controller in case of brake controller failure, and in response to brake controller failure, reducing S2, 601 the configured wheel slip limit λ_{CON}, 710 associated with the failed brake controller to a reduced wheel slip limit λ_{LOW}, 730. Thus, the method summarizes some key aspects of the brake system operations discussed above.

According to some aspects, the method comprises obtaining S3 data related to road friction from a functional brake controller, and configuring S4 the wheel slip limit λ_{LIM} ᵢ associated with the failed brake controller in dependence of the data related to road friction.

According to some such aspects, the data related to road friction comprises a peak wheel slip value λ_{PEAK} detected by the functional brake controller S31.

According to other such aspects, the functional brake controller is a brake controller associated with a wheel on the same side of the vehicle 100 as the failed brake controller S32.

The method optionally also comprises increasing S5 the configured wheel slip limit λ_{LIM} ᵢ associated with the failed brake controller from the reduced wheel slip limit λ_{LOW}, 730 up to a back-up mode wheel slip limit λ_{BU}, 770.

FIG. 9 schematically illustrates, in terms of a number of functional units, the components of a control unit 110 according to embodiments of the discussions herein. This control unit 110 may be comprised in the vehicle 100. Processing circuitry 910 is provided using any combination of one or more of a suitable central processing unit CPU, multiprocessor, microcontroller, digital signal processor DSP, etc., capable of executing software instructions stored in a computer program product, e.g. in the form of a storage medium 930. The processing circuitry 910 may further be provided as at least one application specific integrated circuit ASIC, or field programmable gate array FPGA.

Particularly, the processing circuitry 910 is configured to cause the control unit 110 to perform a set of operations, or steps, such as the methods discussed in connection to FIG. 8. For example, the storage medium 930 may store the set of operations, and the processing circuitry 910 may be configured to retrieve the set of operations from the storage medium 930 to cause the control unit 110 to perform the set of operations. The set of operations may be provided as a set of executable instructions. Thus, the processing circuitry 910 is thereby arranged to execute methods as herein disclosed.

The storage medium 930 may also comprise persistent storage, which, for example, can be any single one or combination of magnetic memory, optical memory, solid state memory or even remotely mounted memory.

The control unit 110 may further comprise an interface 920 for communications with at least one external device such as a suspension system sensor or IMU. As such the interface 920 may comprise one or more transmitters and receivers, comprising analogue and digital components and a suitable number of ports for wireline or wireless communication.

The processing circuitry 910 controls the general operation of the control unit 110, e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIG. 10 illustrates a computer readable medium 1010 carrying a computer program comprising program code means 1020 for performing the methods illustrated in FIG. 10, when said program product is run on a computer. The computer readable medium and the code means may together form a computer program product 1000.

1. A braking system for a heavy duty vehicle, the braking system comprising a first brake controller arranged to control braking on a first wheel, and a second brake controller arranged to control braking on a second wheel, based on a respective wheel slip limit and on a respective brake torque request, wherein the first and the second brake controllers are interconnected via a back-up connection arranged to allow one of the first and the second brake controller to assume braking control of the wheel of the other of the first and the second brake controller in case of brake controller failure, the braking system comprising a control unit arranged to, in response to brake controller failure, reduce the wheel slip limit associated with the failed brake controller to a reduced wheel slip limit.

2. The braking system according to claim 1, wherein the first brake controller is arranged to control braking on a front axle left wheel and wherein the second brake controller is arranged to control braking on a front axle right wheel, whereby the first and second brake controllers are arranged as fail-operational brake controllers.

3. The braking system according to claim claim 1, wherein the control unit is arranged to obtain data related to road friction from a functional brake controller, and to configure the wheel slip limit with the failed brake controller in dependence of the data related to road friction.

4. The braking system according to claim 3, wherein the data related to road friction comprises a peak wheel slip value detected by the functional brake controller and/or an estimated road friction coefficient.

5. The braking system according to claim 1, wherein the reduced wheel slip limit is determined based on a table of reduced slip limits, wherein the table of reduced slip limits is configured to be indexed by a wheel slip value determined for a wheel on the same side of the vehicle as the failed brake controller.

6. The braking system according to claim 1, wherein the reduced wheel slip limit is determined as the smallest peak wheel slip detected by a functional brake controller of a wheel on the same side of the vehicle as the failed brake controller, and reduced by a pre-determined safety factor.

7. The braking system according to claim claim 1, wherein the control unit is arranged to increase brake torque and/or wheel slip limit on one or more trailer wheels in response to front axle brake controller failure.

8. The braking system according to claim 1, wherein the control unit is arranged to increase the configured wheel slip limit associated with the failed brake controller from the reduced wheel slip limit up to a back-up mode wheel slip limit.

9. The braking system according to claim 8, wherein the back-up mode wheel slip limit is smaller or equal to the initially configured wheel slip limit.

10. The braking system according to claim 8, wherein the increase from the reduced wheel slip limit up to the back-up mode wheel slip limit is a linear function.

11. The braking system according to claim 1, wherein a wheel speed sensor associated with a wheel on the front axle is arranged cross-wise connected to a brake controller associated with a wheel on the other side of the front axle.

12. The braking system according to claim 1, wherein the vehicle comprises first second rear wheel axles, wherein a wheel speed sensor associated with a wheel on the first rear axle is arranged connected to a brake controller associated with a wheel on the second rear wheel axle and on the same side as the wheel on the first rear axle.

13. The braking system according to claim 12, wherein a rear axle wheel brake controller is arranged to detect wheel lift-off by comparing wheel speed sensor output from respective first rear axle wheel speed sensor and second rear axle wheel speed sensor, wherein the control unit is arranged to reduce the configured wheel slip limit associated with the brake controller that detects wheel lift-off.

14. A vehicle comprising the braking system according to claim 1.

15. A method for braking a heavy duty vehicle, the method comprising; configuring a braking system comprising a first brake controller arranged to control braking on a first wheel, and a second brake controller arranged to control braking on a second wheel, based on a respective configured wheel slip limit and on a respective brake torque request, wherein the first and the second brake controllers are interconnected via a back-up connection arranged to allow one of the first and the second brake controller to assume braking control of the wheel of the other of the first and the second brake controller in case of brake controller failure, and in response to brake controller failure, reducing the configured wheel slip limit associated with the failed brake controller to a reduced wheel slip limit.

16. The method according to claim 15, comprising obtaining data related to road friction from a functional brake controller, and configuring the wheel slip limit associated with the failed brake controller in dependence of the data related to road friction.

17. The method according to claim 15, comprising increasing the configured wheel slip limit associated with the failed brake controller from the reduced wheel slip limit up to a back-up mode wheel slip limit.

18. A computer program comprising program code means for performing the steps of claim 15 when said program is run on a computer or on processing circuitry of a control unit.

19. A computer readable medium carrying a computer program comprising program code means for performing the steps of claim 15 when said program product is run on a computer or on processing circuitry of a control unit.
